(19) United States
(12) Patent Application Publication
(10) Pub. No.: US 2019/0346754 A1
(43) Pub. Date: Nov. 14, 2019

(54) CONTROL APPARATUS CONTROLLING PROJECTION APPARATUSES, CONTROL METHOD, AND STORAGE MEDIUM

(71) Applicant: CANON KABUSHIKI KAISHA, Tokyo (JP)

(72) Inventor: Kensuke Inagaki, Tokyo (JP)

(21) Appl. No.: 16/389,447

(22) Filed: Apr. 19, 2019

(30) Foreign Application Priority Data
May 10, 2018 (JP) 2018-091779

(51) Int. Cl. G03B 21/20; H04N 9/31

(52) U.S. Cl. CPC G03B 21/206; H04N 9/3147

(57) ABSTRACT

A control apparatus controls a plurality of projection apparatuses performing stack projection or multiple projection, and includes a reception unit configured to receive an instruction from a user to change a stack projection area or a multiple projection area of the plurality of projection apparatuses, and a control unit configured to control a first projection apparatus and a second projection apparatus of the plurality of projection apparatuses in a different manner in a case where the stack projection area or the multiple projection area exceeds a projection area of the first projection apparatus and does not exceed a projection area of the second projection apparatus when the stack projection area or the multiple projection area is changed based on the instruction.

### BACKGROUND

### Field of the Disclosure

The present disclosure relates to a control apparatus that controls a plurality of projection apparatuses performing stack projection or multiple projection, a control method and a storage medium.

### Description of the Related Art

In recent years, projection of contents to various places by a projector is commonly performed. In addition, stack projection in which images are projected by a plurality of projectors so as to be overlapped with one another to form a high-luminance image, a multiple (tile) projection in which images are arranged and projected by a plurality of projectors to form a large-area image, and the like have been widely used.

To perform such stack projection or multiple projection, it is necessary to adjust projection positions of the plurality of projectors with high accuracy. Therefore, the adjustment is performed with use of dedicated software to adjust the projection positions in some cases. Such software includes a function to adjust the projection positions after the stack projection or the multiple projection is once performed.

As a method of adjusting a projection position, Japanese Patent Application Laid-Open No. 2006-246306 discusses a method of electronically shifting and adjusting a position of a projected image.

In the stack projection or the multiple projection, it is difficult to precisely set the projection positions of all of the projectors at the same position. Therefore, a common area is set inside projection surfaces of the plurality of projectors with use of a four-point keystone function in which four corners of a projection surface are arbitrarily set. For example, in the stack projection, two projectors 7100a and 7100b respectively perform projection to projection areas 710a and 710b, to perform the stack projection in a hatched stack projection area 20, as illustrated in FIG. 7A. After such adjustment is performed, the position of the stack projection area 20 is required to be adjusted manually in some cases. Such a case is described with reference to FIG. 7B. FIG. 7B is a diagram illustrating the projection surface of FIG. 7A viewed from a front side. In FIG. 7B, for example, when rightward movement of a lower-right vertex of the stack projection area 20 is desired as illustrated by an arrow, the lower-right vertex cannot be moved rightward any more because the lower-right vertex is located on a right side of the projection area 710a of the projector 7100a. A user viewing the projection surface, however, may not notice that the stack projection area 20 has reached an end point of the projection area 710a because the user views the projection area 710b of the projector 7100b at the same time. The multiple projection also has similar issues as illustrated in FIG. 7C. FIG. 7C is a diagram illustrating a projection surface in the multiple projection using three projectors. Reference numerals 710a to 710c denote projection areas of the three projectors, and a hatched area 70 denotes a multiple projection area. In this state, in a case where a lower-right vertex of the multiple projection area 70 is moved downward, the lower-right vertex cannot be moved downward any more because the multiple projection area 70 exceeds the projection area 710b. The user viewing the projection surface, however, may not notice that the multiple projection area 70 exceeds the projection area 710b if the user focuses on the projection area 710c near the lower-right vertex.

The technology discussed in Japanese Patent Application Laid-Open No. 2006-246306 cannot suitably notify the user that the stack projection area or the multiple projection area reaches a limit of a projection area of a projector in a case where the above-described adjustment of the stack projection or the multiple projection is performed.

### SUMMARY

The present disclosure is directed to a control apparatus controlling a plurality of projection apparatuses that can perform notification to the user in a case where a projection area of a projection apparatus reaches a limit in adjustment of a projection position of stack projection or multiple projection.

According to an aspect of the present disclosure, a control apparatus controls a plurality of projection apparatuses performing stack projection or multiple projection, and includes a reception unit configured to receive an instruction from a user to change a stack projection area or a multiple projection area of the plurality of projection apparatuses, and a control unit configured to control a first projection apparatus and a second projection apparatus of the plurality of projection apparatuses in a different manner in a case where the stack projection area or the multiple projection area exceeds a projection area of the first projection apparatus and does not exceed a projection area of the second projection apparatus when the stack projection area or the multiple projection area is changed based on the instruction.

Further features of the present disclosure will become apparent from the following description of exemplary embodiments with reference to the attached drawings.

### BRIEF DESCRIPTION OF THE DRAWINGS

FIG. 1 is a diagram illustrating an example of a projection system to which the present disclosure is applied.

FIG. 2 is a configuration diagram illustrating a projection system according to one or more aspect of the present disclosure.

FIG. 3 is a diagram illustrating an example of a graphical user interface (GUI) screen of an automatic alignment program.

FIG. 4 is a diagram illustrating an example of a processing flow of the automatic alignment program.

FIG. 5 is a diagram illustrating an example of a processing flow of manual adjustment processing according to one or more aspect of the present disclosure.

FIGS. 6A, 6B and 6C are diagrams each illustrating a state of a projection surface in the manual adjustment processing.

FIGS. 7A and 7B are diagrams each illustrating relationship between projection areas of respective projectors and the entire projection surface in stack projection, and FIG. 7C is a diagram illustrating relationship between projection areas of respective projectors and the entire projection surface in multiple projection.

### DESCRIPTION OF THE EMBODIMENTS

Although an exemplary embodiment of the present disclosure is described in detail below with reference to the attached drawings, the present disclosure is not limited to the following exemplary embodiment. Further, the exemplary embodiment of the present disclosure illustrates a preferred embodiment, and does not limit the scope of the present disclosure.

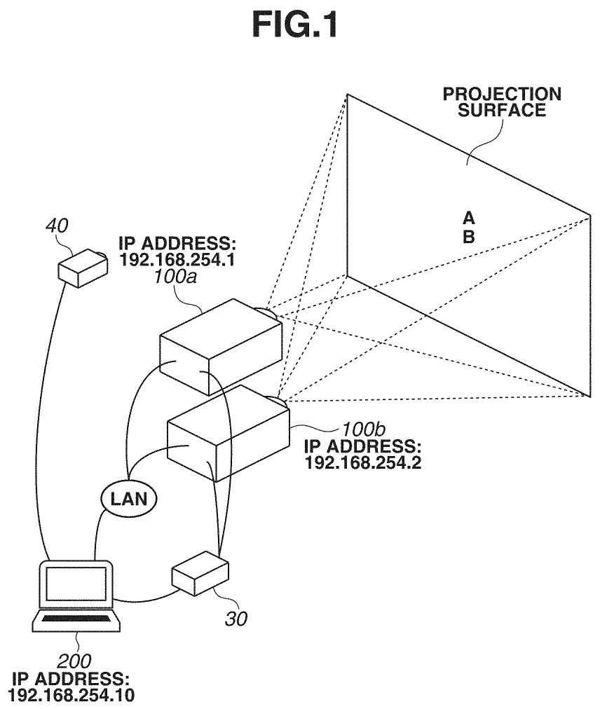

FIG. 1 is a diagram illustrating an example of a projection system to which the present disclosure is applied. In the present exemplary embodiment, a case where stack projection is performed by two projectors as illustrated in FIG. 1 is described to simplify description; however, the number and arrangement of projectors are not limited thereto.

A projector 100a and a projector 100b respectively project an image A and an image B, and superimpose the images on a projection surface to project one high-luminance image.

An automatic alignment program described below operates in a personal computer (PC) 200. The projector 100a, the projector 100b, and the PC 200 are connected to one another through a communication network so as to be communicable with one another.

An image distributor 30 supplies image signals to the projector 100a and the projector 100b through a plurality of image cables. As a format of the image signals, any format such as High-Definition Multimedia Interface (HDMI®), digital visual interface (DVI), and video graphics array (VGA) can be used. The image distributor 30 duplicates the image signal received from the PC 200, and supplies the duplicated signals to the projector 100a and the projector 100b. In the present exemplary embodiment, the example in which the image output from the PC 200 is supplied by the image distributor 30 has been described; however, the image can be supplied by another method. Image data can be supplied from the PC 200 to each of the projector 100a and the projector 100b through, for example, network communication. The image distributor 30 is unnecessary in the case where the other method is used.

A camera 40, which is connected to the PC 200 through a universal serial bus (USB) cable or a local area network (LAN) cable, captures a projection surface based on a capturing instruction from the PC 200 and transmits a captured image to the PC 200. The camera 40 is an imaging apparatus that can perform image capturing based on the instruction from the PC 200 and a kind of the camera 40 is not limited.

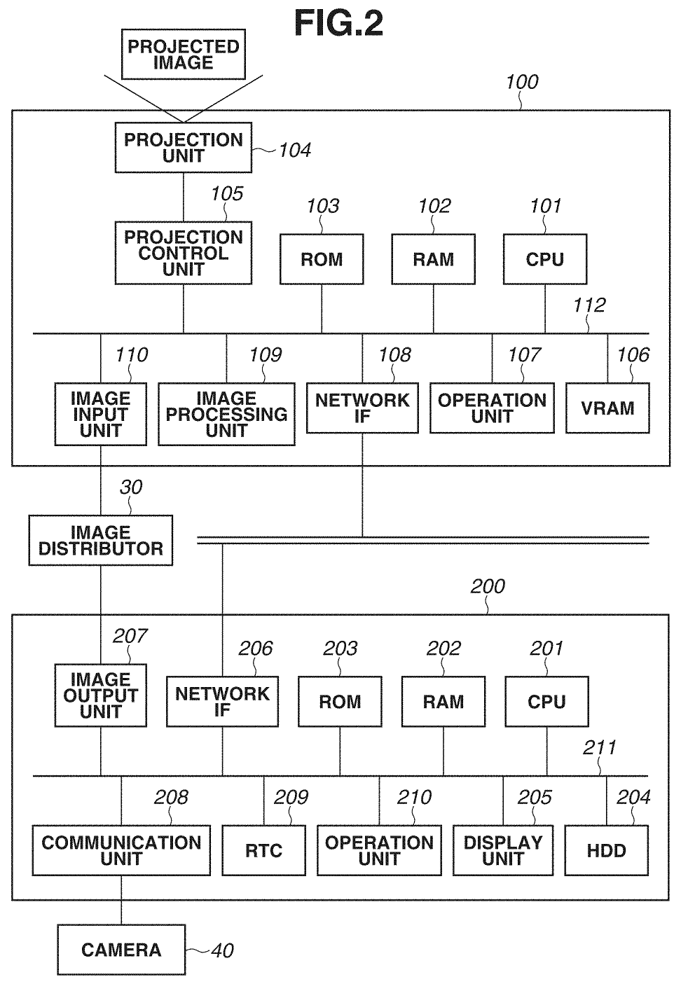

FIG. 2 is a diagram illustrating a main configuration of the projection system according to the present exemplary embodiment.

The projector 100a and the projector 100b in FIG. 1 have the same configuration, and are accordingly described as a projector 100 herein. The projector 100 according to the present exemplary embodiment includes a central processing unit (CPU) 101, a random access memory (RAM) 102, a read-only memory (ROM) 103, a projection unit 104, a projection control unit 105, a video random access memory (VRAM) 106, an operation unit 107, a network interface (IF) 108, an image processing unit 109, and an image input unit 110. Further, a system bus 112 connects the above-described units.

The CPU 101 controls each of operation units in the projector 100.

The RAM 102 serves as a working memory that temporarily stores a control program and data.

The ROM 103 stores a control program in which a processing procedure of the CPU 101 is described.

The projection unit 104 projects an image instructed by the projection control unit 105 described below, and includes a liquid crystal panel, a lens, and a light source such as a lamp that are not illustrated.

The projection control unit 105 reads out image data stored in the VRAM 106, and instructs the projection unit 104 to perform projection.

The VRAM 106 is an area where an image to be projected by the projection unit 104 is stored. A graphical user interface (GUI) is drawn by the CPU 101 on the VRAM 106.

The operation unit 107 receives an instruction from a user as a reception unit, and transmits an instruction signal to the CPU 101. The operation unit 107 includes, for example, a switch and a dial. Alternatively, the operation unit 107 may receive a signal from a remote controller not illustrated, and may transmit an instruction signal corresponding to the received signal to the CPU 101.

The network IF 108 is to perform network communication with an external apparatus.

The image processing unit 109 performs various kinds of image processing on an image signal received from the image input unit 110 described below, and transmits the resultant signal to the projection control unit 105. More specifically, the image processing unit 109 performs image processing such as frame thinning processing, frame interpolation processing, internet protocol (IP) conversion processing, resolution conversion processing, distortion correction processing (keystone correction processing), and edge blending.

The image input unit 110 receives an input signal from an external apparatus, and develops the signal for each frame on the VRAM 106.

Now, the PC 200 is described.

The PC 200 according to the present exemplary embodiment includes a CPU 201, a RAM 202, a ROM 203, a hard disk drive (HDD) 204, a display unit 205, a network IF 206, an image output unit 207, a communication unit 208, a real-time clock (RTC) 209, and an operation unit 210. An internal bus 211 connects the above-described units.

The CPU 201 controls each of the operation units in the PC 200.

The RAM 202 serves as a working memory that temporarily stores a control program and data.

The ROM 203 stores a boot program that is executed by the CPU 201 in initialization. In the boot program, processing in which an operating system (OS) recorded in the HDD 204 described below is developed to the RAM 202 and is started is performed.

The HDD 204 is used to store various kinds of programs such as an application program and the OS, and data.

The display unit 205 displays image data and a user interface (UI) screen. The display unit 205 is, for example, a liquid crystal panel or an organic electroluminescence (EL) panel.

The network IF 206 is to perform network communication with an external apparatus. In the present exemplary embodiment, communication with the projector 100 that is connected through LAN is performed. Although the projector 100 is controlled through the LAN communication in the present exemplary embodiment, the communication method is not limited to the LAN communication and any other communication method can be used. For example, serial communication (RS-232) can be used. In this case, the PC 200 is connected to the projector 100 through the communication unit 208 described below.

The image output unit 207 transmits an image signal to an external apparatus. The image output unit 207 includes, for example, a composite terminal, a separate (S) image terminal, a D terminal, a component terminal, an analog red-green-blue (RGB) terminal, a DVI-I terminal, a DVI-D terminal, an HDMI® terminal, and a DisplayPort terminal.

The communication unit 208 performs transmission and reception of a signal including a capturing instruction, an exposure correction instruction, etc., and a captured image, with respect to the camera 40. The transmission and reception are performed by the standard such as USB and Recommended Standard (RS)-232. Although a case where the PC 200 and the camera 40 are connected by the communication unit 208 through the USB is described in the present exemplary embodiment, the PC 200 and the camera 40 can be connected by the network IF 206 through network as long as the camera 40 is controllable through the network.

### <Basic Operation of Automatic Adjustment>

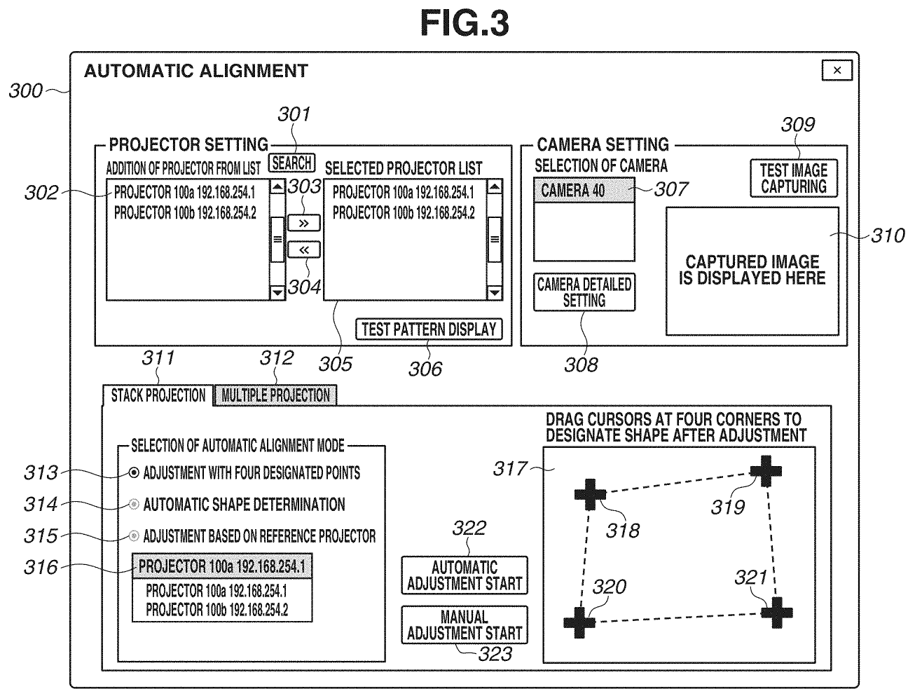

FIG. 3 is a diagram illustrating an example of a GUI 300 of an automatic alignment program operating in the PC 200. An adjustment procedure by the automatic alignment program is described with reference to FIG. 3.

First, a user starting up the automatic alignment program presses down a search button 301 to search a projector in the same network. When the search button 301 is pressed down, the CPU 201 transmits, for example, a packet of a protocol that has been previously determined with the projector through the network IF 206, and searches a projector by receiving a response packet from the projector. For example, a broadcast packet of a user datagram protocol (UDP) can be used to search an apparatus in the same network as described above. The projector can be searched with use of a protocol other than the UDP. The CPU 201 displays a search result in a search result list view 302, based on response packet information from the projector. When the search button 301 is pressed down in the configuration as illustrated in FIG. 1, projector names set to the respective projectors 100a and 100b with IP addresses are displayed in the search result list view 302.

Next, the user selects a projector to be used for projection from the searched projectors in the search result list view 302, and presses down a selected projector addition button 303 to select a desired projector as a projection target. The selected projector is displayed in a selected projector list view 305. In a case where the projector once selected is removed from the projection target, the projector is selected in the selected projector list view 305 and a selected projector deletion button 304 is pressed down to remove the projector from the projection target. A test pattern display button 306 is used to verify the selected projector. When the test pattern display button 306 is pressed down by the user, the CPU 201 causes each of the projectors 100a and 100b displayed in the selected projector list view 305 to display a test pattern. The test pattern displayed by the projector can be any pattern such as a test pattern to display a single color on an entire projection surface. In the example of FIG. 1, it is difficult to determine whether the correct projector has been selected, only from the information displayed on the selected projector list view 305 in an environment in which a plurality of projectors is connected to the network. The test pattern display button 306 is provided and the plurality of projectors display the test patterns, which makes it possible to prevent selection and adjustment of an incorrect projector.

A camera selection drop-down list 307 causes the user to select one camera to be used for automatic alignment from a list of cameras connected to the PC 200. In the projection system illustrated in FIG. 1, only one camera 40 is connected to the PC 200. Therefore, only one camera is displayed in the camera selection drop-down list 307. In a case where a plurality of cameras is connected, the plurality of cameras is displayed in the camera selection drop-down list 307, so that the user can select a desired camera to use the camera in the subsequent automatic adjustment.

A camera detailed setting button 308 causes the user to perform setting of parameters (e.g., shutter speed, International Organization for Standardization (ISO) sensitivity, aperture value, and capturing resolution) of the camera. When the camera detailed setting button 308 is pressed down, a dialog, which is not illustrated, to set the parameters of the camera is displayed, and the user can perform setting of the camera by inputting the parameters such as the shutter speed, the ISO sensitivity, the aperture value, and the capturing resolution.

When the user presses down a test image capturing button 309, a live view image of the camera is displayed in an image display area 310. The user can verify whether all of projection areas (test patterns) of the projectors to be automatically aligned are within a field angle of the camera 40, or whether the parameters of the camera have been correctly set.

After the user selects the projectors and the camera, the user selects one of a stack projection tab 311 and a multiple projection tab 312 based on projection to be adjusted. In the present exemplary embodiment, subsequent processing in a case where the stack projection has been selected is described.

Radio buttons 313, 314, and 315 cause the user to select an automatic alignment mode. The automatic alignment mode in the stack projection mode includes three modes of “adjustment with four designated points”, “automatic shape determination”, and “adjustment based on reference projector”.

The mode of “adjustment with four designated points” corresponds to an adjustment method of causing the user to designate coordinates at four corners and deforming the plurality of projectors based on the designated coordinates. The coordinates at the four corners are designated, for example, by a method in which the user moves adjustment points 318, 319, 320, and 321 to arbitrary positions in a four-point adjustment area 317 through a drag-and-drop operation. The adjustment points 318, 319, 320, and 321 respectively indicate adjustment vertex coordinates at upper left, upper right, lower left, and lower right. The adjustment mode of “adjustment with four designated points” is effective to a case where a projection target position is clear as with a case where the projection surface is a screen with a frame.

The number of adjustment points is not limited to four points, and a mode provided with a plurality of adjustment points can be provided.

The mode of “automatic shape determination” corresponds to an adjustment method of deforming each of the projection areas (projection areas of respective projectors corresponding to stack projection area) into a rectangle shape with respect to the projection surface through calculation processing by the CPU 201. The designation of the projection positions is unnecessary in the adjustment method, which reduces trouble of the user. This mode is effective to a case where the projection target position is not clear (e.g., projection to a wide wall surface).

The mode of “adjustment based on reference projector” corresponds to an adjustment method of causing the user to select one projector from the projectors in a reference-projector selection drop-down list 316 and deforming the projection areas of the other projectors so as to be matched with the projection area of the selected projector. The contents of the reference-projector selection drop-down list 316 is the same as the contents of the above-described selected projector list view 305, and only selected projectors to be adjusted are displayed.

After the user selects the automatic alignment mode and designates the adjustment vertices, the user presses down an automatic adjustment start button 322 to start automatic adjustment.

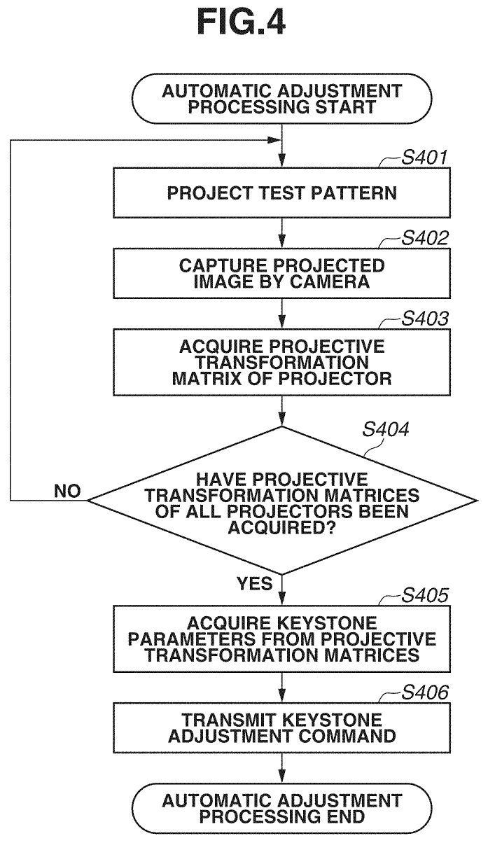

When the automatic adjustment start button 322 is pressed down, the CPU 201 starts automatic adjustment processing illustrated in FIG. 4.

In step S401, the CPU 201 selects one projector from the projectors to be adjusted, and causes the projector to project a test pattern. More specifically, for example, the test pattern is displayed on the display unit 205 of the PC 200, the image distributor 30 transmits the image of the test pattern, and the projector displays the image. At this time, the CPU 201 previously transmits a control command to the projectors other than the projector that performs test pattern display, through the network IF 206, to prevent the projectors other than the projector that performs test pattern display from performing image display. The control command can be transmitted with use of a protocol such as a transmission control protocol (TCP).

In step S402, the CPU 201 controls the camera 40 through the communication unit 208 to capture a projected image, and stores the captured image in the RAM 202.

In step S403, the CPU 201 calculates and acquires a projective transformation matrix of the projector based on the captured image acquired in step S402. The projective transformation matrix used herein indicates a matrix to perform projective transformation from a camera coordinate system to a panel coordinate system of the projector. The projective transformation matrix can be calculated by extracting a plurality of feature points of the test pattern projected in step S401 from the captured image acquired in step S402 and determining correspondence relationship of the feature points.

In step S404, the CPU 201 determines whether the projective transformation matrices for all of the projectors to be adjusted have been acquired. In a case where all of the projective transformation matrices have not been acquired (NO in step S404), the projector projecting the test pattern is sequentially switched, and the processing in steps S401 to S403 is repeated.

After the projective transformation matrices for all of the projectors to be adjusted have been calculated (YES in step S404), the CPU 201 calculates and acquires keystone parameters of all of the projectors as an acquisition unit in step S405. More specifically, for example, coordinates in the panel coordinate system of the coordinate points at the four corners in the projection area of each of the projectors are calculated. The coordinates can be calculated from the corresponding projective transformation matrix calculated in step S403 and the target points designated by the user with use of the adjustment points 318, 319, 320, and 321 in FIG. 3. In the present specification, the projective transformation matrices and the keystone parameters are also referred to as deformation parameters.

In step S406, the CPU 201 transmits a control command based on the keystone parameters calculated in step S405 through the network IF 206, to perform keystone adjustment of all of the projectors to be adjusted. The automatic adjustment processing then ends. The control command can be transmitted with use of a protocol such as a TCP.

After the automatic adjustment, the user can press down a manual adjustment start/end button 323, and can perform manual adjustment by designating four points on the adjusted projection surface. The manual adjustment operation is described in detail below. The manual adjustment start/end button 323 is a toggle button in which a text of “manual adjustment start” is displayed before start of the manual adjustment, and a text of “manual adjustment end” is displayed after start of the manual adjustment. The user can instruct start of the manual adjustment before start of the manual adjustment and instruct end of the manual adjustment after start of the manual adjustment by pressing down the manual adjustment start/end button 323.

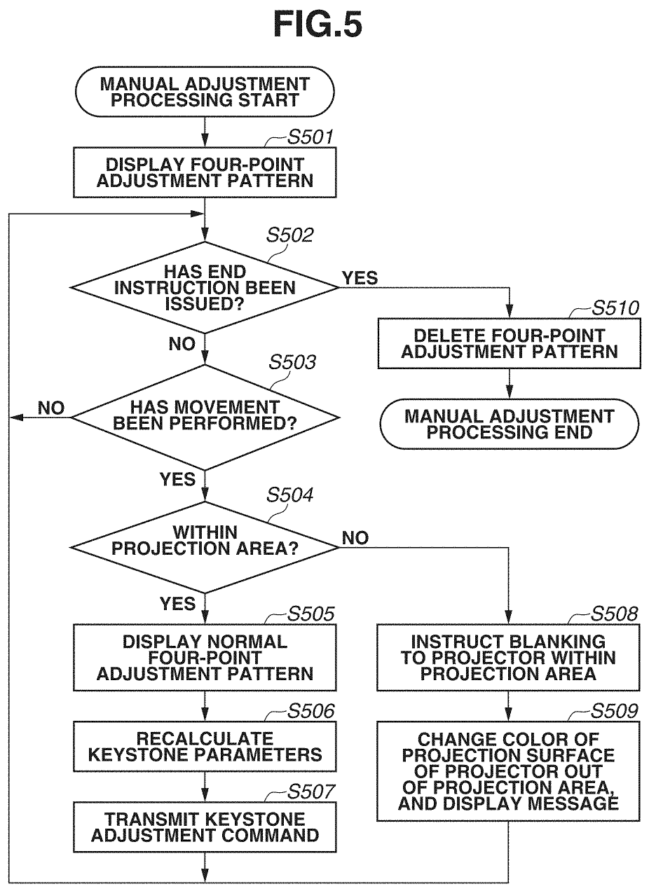

In a case where the manual adjustment after the automatic adjustment is necessary, the user presses down the manual adjustment start/end button 323 to start the manual adjustment processing illustrated in FIG. 5.

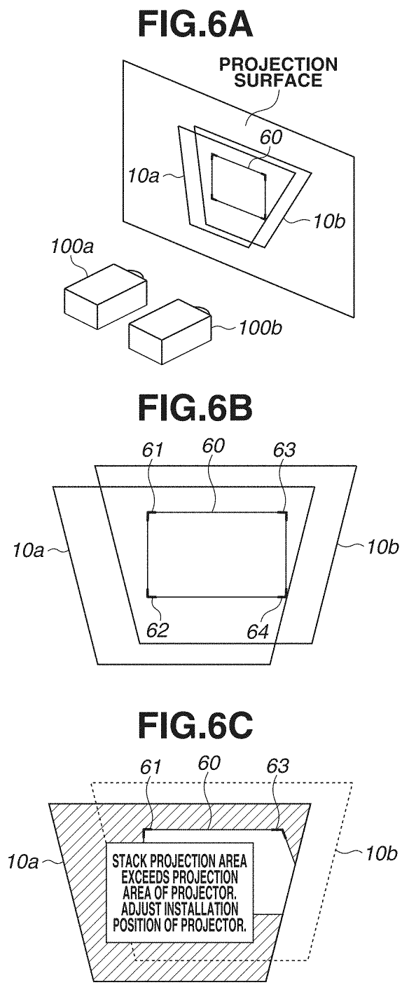

In step S501, the CPU 201 projects, for example, a four-point adjustment pattern 60 illustrated in FIG. 6A to a stack projection area. FIG. 6B is a diagram illustrating a projection surface of FIG. 6A viewed from the front side. Projection areas 10a and 10b respectively correspond the projectors 100a and 100b, and FIG. 6B illustrates a state in which the four-point adjustment pattern 60 is projected in the projection areas. The four-point adjustment pattern 60 includes markers 61 to 64 representing four corners of the stack projection area and line segments connecting the markers, and is configured such that a contour of the stack projection area and vertices at the four corners are recognizable.

Further, the markers 61 to 64 representing the four corners respectively correspond to the adjustment points 318 to 321 in the GUI in FIG. 3, and the user can adjust the positions of the markers 61 to 64 by selecting and moving one of the adjustment points 318 to 321. The four-point adjustment pattern 60 can be displayed by, for example, displaying the four-point adjustment pattern 60 on the display unit 205 of the PC 200 and transmitting the image of the pattern by the image distributor 30. Alternatively, a drawing instruction command for the four-point adjustment pattern 60 can be transmitted from the network IF 206 to the projector. In step S502, the CPU 201 determines whether the user has issued a manual adjustment end instruction through the operation unit 210. The manual adjustment end instruction from the user is determined based on whether the manual adjustment start/end button 323 has been pressed down. In a case where the manual adjustment end has been instructed (YES in step S502), the CPU 201 deletes the four-point adjustment pattern 60 in step S510, and the manual adjustment processing ends. The four-point adjustment pattern 60 is deleted through, for example, deletion of the four-point adjustment pattern 60 displayed on the display unit 205 of the PC 200 in step S501. Alternatively, in a case where the drawing instruction command for the four-point adjustment pattern 60 has been transmitted from the network IF 206 to the projector in step S501, the four-point adjustment pattern 60 can be deleted through transmission of a deletion instruction command for the four-point adjustment pattern 60 through the network IF 206.

In a case where the end instruction has not been received (NO in step S502), the CPU 201 determines whether the adjustment points at the four corners have been moved through the operation unit 201 in step S503. In a case where the adjustment points have not been moved (NO in step S503), the processing in steps S502 and S503 is repeated. The adjustment points at the four corners are moved through drag of any of the adjustment points 318 to 321 in FIG. 3 by the user with a mouse as described above. The initial display of the adjustment points 318 to 321 in FIG. 3 is performed based on the image captured by the camera 40. Accordingly, the positional adjustment of the adjustment points 318 to 321 corresponds to an instruction of positional adjustment of the coordinate points in the camera coordinate system.

In a case where the movement has been instructed (YES in step S503), the CPU 201 calculates the coordinate points of all of the projectors after the movement instruction, and determines whether the coordinate points are within the projection areas of the respective projectors in step S504. In a case where it is determined that the coordinate points are within the projection areas of the respective projectors (YES in step S504), the CPU 201 performs the processing same as the processing in step S501 on all of the projectors, and displays the normal four-point adjustment pattern again in step S505. The processing in step S505 is processing to return the display to a normal projection state as illustrated in FIG. 6B in a case where the display of each of the projectors has been changed by processing in steps S508 and S509 described below. In the present exemplary embodiment, the processing in step S505 is surely performed; however, if the processing in steps S508 and S509 has not been performed before the processing in step S505, the processing in step S505 can be skipped.

Then, in step S506, the CPU 201 calculates the keystone parameters of all of the projectors. More specifically, the keystone parameters of all of the projectors are calculated from the projective transformation matrices to perform projective transformation from the camera coordinate system to the panel coordinate system of the respective projectors calculated in step S403 of the automatic adjustment processing and the positions of the four corners after movement in the camera coordinate system designated by the user. In step S507, the CPU 201 transmits a control command based on the keystone parameters calculated in step S506 through the network IF 206. The processing is then returned to step S502 and is continued.

In a case where it is determined in step S504 that the coordinate point exceed the projection area of any of the projectors (NO in step S504), the CPU 201 transmits a control command to all of the projectors in which the coordinate point is within the own projection area, through the network IF 206, to temporarily delete the projected images in step S508. Hereinafter, deletion of the projected image is referred to as blanking. Then, in step S509, the CPU 201 transmits a control command to the projector in which the coordinate point is determined to exceed the own projection area, through the network IF 206, causes the projector to change the color of the projection area, and causes the projector to display a message that notifies the user that the stack projection area exceeds the projection area. FIG. 6C is a diagram illustrating an example of the display on the projection surface by the processing in steps S508 and S509. FIG. 6C illustrates an example in which the user moves the lower-right marker 64 rightward from the state of FIG. 6B, and the marker 64 (coordinate point) exceeds the projection area 10a of the projector 100a as a result. A projection area 10b of the projector 100b is illustrated by a dashed line in FIG. 6C, and is not visible by the user because the blanking has been instructed in step S508. In contrast, the projection area 10a of the projector 100a illustrated by oblique lines is easily visible by the user because the color of the projection area 10a has been changed in step S509. As illustrated in FIG. 6C, making the display mode of the projector in which the stack projection area exceeds the own projection area and the display mode of the other projectors different from each other enables the user to easily view that the stack projection area exceeds the projection area of which projector.

Further, as illustrated in step S509 of FIG. 5 and FIG. 6C, a message to prompt adjustment of a projector installation position is displayed on the projection area of the projector in which the stack projection area exceeds the own projection area. This configuration enables the user to promptly recognize necessity of change of the projector installation position. This makes it possible to reduce a time for installation adjustment.

Although the example in which the message is displayed on the projection area has been described in the present exemplary embodiment, a notification that the stack projection area exceeds the projection area can be made by another method. For example, the projector in which the stack projection area exceeds the own projection area can be notified to the user by changing a light emitting mode, for example, blinking a light emitting device such as a light emitting diode (LED), which is not illustrated, mounted on the projector 100a. Alternatively, the projector in which the stack projection area exceeds the own projection area can be notified to the user by changing a sound output mode, for example, sounding a sound output device such as a speaker, which is not illustrated, mounted on the projector 100a. This configuration enables the user to easily recognize that the stack projection area exceeds the projection area of which projector, even in a case where the projectors are disposed at close positions.

Although the example in which the notification is made to the user in the case where the adjustment points are moved outside the projection area of any of the projectors as illustrated in FIG. 6C has been described in the present exemplary embodiment, the adjustment points can be controlled so as to stay within the projection area of each of the projectors. In such a configuration, the processing in steps S508 and S509 in FIG. 5 can be performed for a predetermined time when the user moves the adjustment points to the outside of the projection area, and control can be performed such that the actual movement of the adjustment points is not performed.

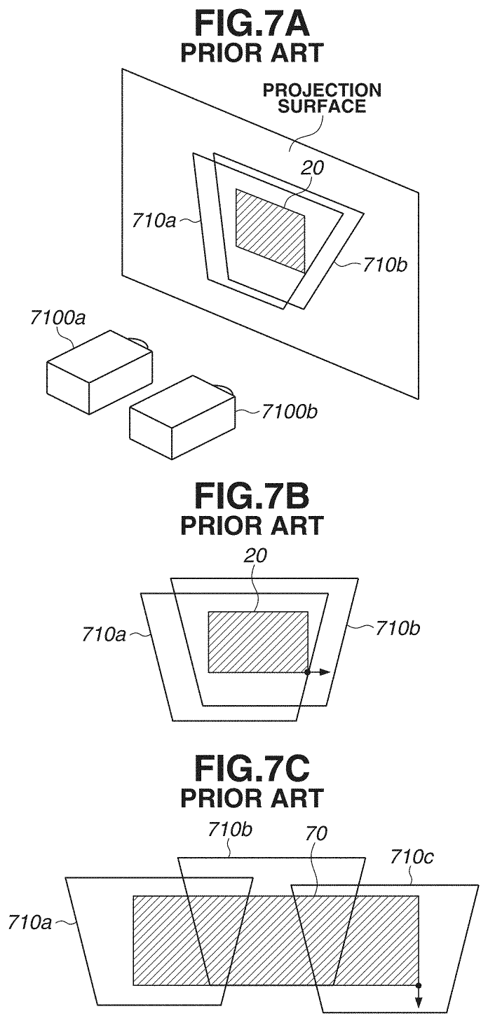

Although the stack projection has been described as an example in the present exemplary embodiment, the present disclosure is applicable to the multiple projection illustrated in FIG. 7C using the similar procedure.

According to the present exemplary embodiment as described above, in the case where the stack projection area or the multiple projection area exceeds a projection area of a projector in positional adjustment of the stack projection area or the multiple projection area, notification can be suitably made to the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2018-091779, filed May 10, 2018, which is hereby incorporated by reference herein in its entirety.

What is claimed is:

1. A control apparatus that controls a plurality of projection apparatuses performing stack projection or multiple projection, the control apparatus comprising:
a reception unit configured to receive an instruction from a user to change a stack projection area or a multiple projection area of the plurality of projection apparatuses; and
a control unit configured to control a first projection apparatus and a second projection apparatus of the plurality of projection apparatuses in a different manner in a case where the stack projection area or the multiple projection area exceeds a projection area of the first projection apparatus and does not exceed a projection area of the second projection apparatus when the stack projection area or the multiple projection area is changed based on the instruction.

2. The control apparatus according to claim 1, wherein the control unit makes an image projected by the first projection apparatus and an image projected by the second projection apparatus different in display mode from each other.

3. The control apparatus according to claim 2, wherein the control unit makes the image projected by the first projection apparatus and the image projected by the second projection apparatus different in color or luminance from each other.

4. The control apparatus according to claim 2, wherein the control unit causes the first projection apparatus to project a message.

5. The control apparatus according to claim 1, wherein the control unit makes a light emitting device mounted on the first projection apparatus and a light emitting device mounted on the second projection apparatus different in light emission mode from each other, or makes a sound output device mounted on the first projection apparatus and a sound output device mounted on the second projection apparatus different in sound output mode from each other.

6. The control apparatus according to claim 1, further comprising an acquisition unit configured to acquire deformation parameters of the plurality of projection apparatuses based on a captured image acquired by capturing images projected by the plurality of projection apparatuses.

7. The control apparatus according to claim 6,
wherein the deformation parameters are projective transformation matrices, and
wherein the acquisition unit acquires the projective transformation matrices to perform projective transformation from a coordinate system of the captured image to a panel coordinate system of each of the plurality of projection apparatuses, based on the captured image.

8. A control apparatus that controls a plurality of projection apparatuses performing stack projection or multiple projection, the control apparatus comprising:
a reception unit configured to receive an instruction from a user to change a stack projection area or a multiple projection area of the plurality of projection apparatuses; and
a control unit configured to notify at least one of the plurality of projection apparatuses in a case where the stack projection area or the multiple projection area exceeds a projection area of the at least one projection apparatus when the stack projection area or the multiple projection area is changed based on the instruction.

9. The control apparatus according to claim 8, wherein the control unit notifies the at least one projection apparatus by changing a display mode of an image projected by the at least one projection apparatus.

10. The control apparatus according to claim 9, wherein the control unit notifies the at least one projection apparatus by changing a color or luminance of the image projected by the at least one projection apparatus.

11. The control apparatus according to claim 9, wherein the control unit notifies the at least one projection apparatus by causing the at least one projection apparatus to project a message.

12. The control apparatus according to claim 8, wherein the control unit notifies which the at least one projection apparatus is by changing a light emitting mode of a light emitting device mounted thereon or a sound output mode of a sound output device mounted thereon.

13. A control method of controlling a plurality of projection apparatuses performing stack projection or multiple projection, the control method comprising:
receiving an instruction from a user to change a stack projection area or a multiple projection area of the plurality of projection apparatuses; and
controlling a first projection apparatus and a second projection apparatus of the plurality of projection apparatuses in a different manner in a case where the stack projection area or the multiple projection area exceeds a projection area of the first projection apparatus and does not exceed a projection area of the second projection apparatus when the stack projection area or the multiple projection area is changed based on the instruction.

14. A control method of controlling a plurality of projection apparatuses performing stack projection or multiple projection, the control method comprising:
receiving an instruction from a user to change a stack projection area or a multiple projection area of the plurality of projection apparatuses; and
notifying at least one of the plurality of apparatuses in a case where the stack projection area or the multiple projection area exceeds a projection area of the at least one projection apparatus when the stack projection area or the multiple projection area is changed based on the instruction.

15. A non-transitory computer readable storage medium storing a program that causes a computer to execute a control method of controlling a plurality of projection apparatuses performing stack projection or multiple projection, the control method comprising:
receiving an instruction from a user to change a stack projection area or a multiple projection area of the plurality of projection apparatuses; and
controlling a first projection apparatus and a second projection apparatus of the plurality of projection apparatuses in a different manner in a case where the stack projection area or the multiple projection area exceeds a projection area of the first projection apparatus and does not exceed a projection area of the second projection apparatus when the stack projection area or the multiple projection area is changed based on the instruction.

16. A non-transitory computer readable storage medium storing a program that causes a computer to execute a control method of controlling a plurality of projection apparatuses performing stack projection or multiple projection, the control method comprising:
receiving an instruction from a user to change a stack projection area or a multiple projection area of the plurality of projection apparatuses; and
notifying at least one of the plurality of apparatuses in a case where the stack projection area or the multiple projection area exceeds a projection area of the at least one projection apparatus when the stack projection area or the multiple projection area is changed based on the instruction.
